(19) United States
(12) Patent Application Publication
(10) Pub. No.: US 2011/0123158 A1
(43) Pub. Date: May 26, 2011

(54) CABLE ASSEMBLY HAVING POSITIONING MEANS SECURING FIBER THEREOF

(75) Inventors: TERRANCE F. LITTLE, York, PA (US); STEPHEN SEDIO, Valley Center, CA (US)

(73) Assignee: HON HAI PRECISION INDUSTRY CO., LTD., Tu-Cheng (TW)

(21) Appl. No.: 12/626,631

(22) Filed: Nov. 26, 2009

(51) Int. Cl. G02B 6/36

(52) U.S. Cl. 385/77; 385/93

(57) ABSTRACT

A cable assembly (100) includes an insulative housing (2) having a base portion (21) and a tongue portion (22) extending forwardly from the base portion, said tongue portion defining a mounting cavity (221) and at least two depressions (224), said two depressions located behind and located within the mounting cavity. An optical module (5) is accommodated in the mounting cavity, said optical module having two lenses. Two fibers (6) pass through the two depressions and coupled to the two lenses, respectively. Two cap members (7) are accommodated in the two depressions to position the fibers therein.

### CROSS-REFERENCE TO RELATED APPLICATIONS

This application is related to U.S. patent application Ser. No. 11/818,100, filed on Jun. 13, 2007 and entitled “EXTENSION TO UNIVERSAL SERIAL BUS CONNECOTR WITH IMPROVED CONTACT ARRANGEMENT”, and U.S. patent application Ser. No. 11/982,660, filed on Nov. 2, 2007 and entitled “EXTENSION TO ELECTRICAL CONNECTOR WITH IMPROVED CONTACT ARRANGEMENT AND METHOD OF ASSEMBLING THE SAME”, and U.S. patent application Ser. No. 11/985,676, filed on Nov. 16, 2007 and entitled “ELECTRICAL CONNECTOR WITH IMPROVED WIRE TERMINATION”, all of which have the same assignee as the present invention.

### BACKGROUND OF THE INVENTION

1. Field of the Invention

The present invention relates to a cable assembly, more particularly to a cable assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connectors and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a kind of connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, In the assembly process of a connector system that uses fiber optic cables, the fibers are stiff by nature. They are also very delicate and require protection if the fibers can be exposed. An example would be, but not limited to a USB connector type of application. The fibers when assembled within the plug housing, have the tendency to drift in unwanted locations due to their stiff nature.

### BRIEF SUMMARY OF THE INVENTION

Accordingly, an object of the present invention is to provide a cable assembly has positioning means for securing fibers thereof.

In order to achieve the above-mentioned object, a cable assembly in accordance with present invention comprises an insulative housing having a base portion and a tongue portion extending forwardly from the base portion, said tongue portion defining a mounting cavity and at least two depressions, said two depressions located behind and located within the mounting cavity. An optical module is accommodated in the mounting cavity, said optical module having two lenses. Two fibers pass through the two depressions and coupled to the two lenses, respectively. Two cap members are accommodated in the two depressions to position the fibers therein.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is an exploded, perspective view of FIG. 1;

FIG. 3 is similar to FIG. 2, but viewed from another aspect;

FIG. 4 is a partially assembled view of the cable assembly;

FIG. 5 is other partially assembly view of the cable assembly;

FIG. 6 is a cross-section view of the cable assembly taken along line 6-6;

FIG. 7 is a partially assembled view of the cable assembly in accordance with the second embodiment of the present invention;

FIG. 8 is other partially assembly view of the cable assembly in accordance with the second embodiment; and

FIG. 9 is an enlarged view of a cap member of the cable assembly in accordance with the second embodiment.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

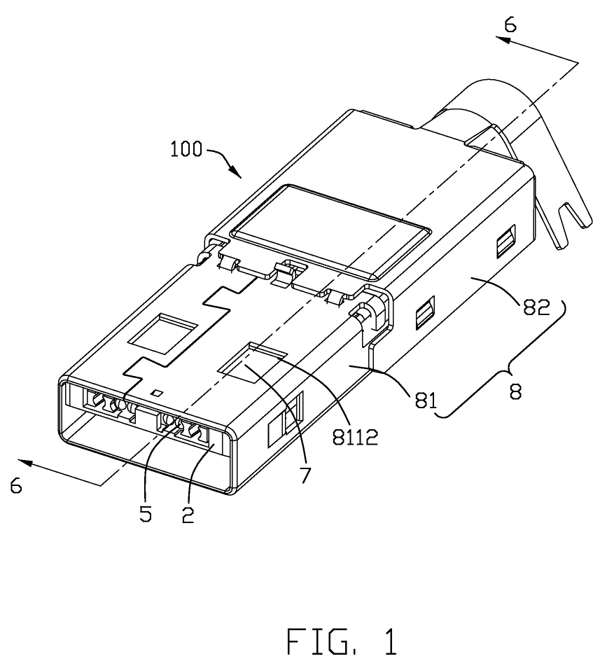

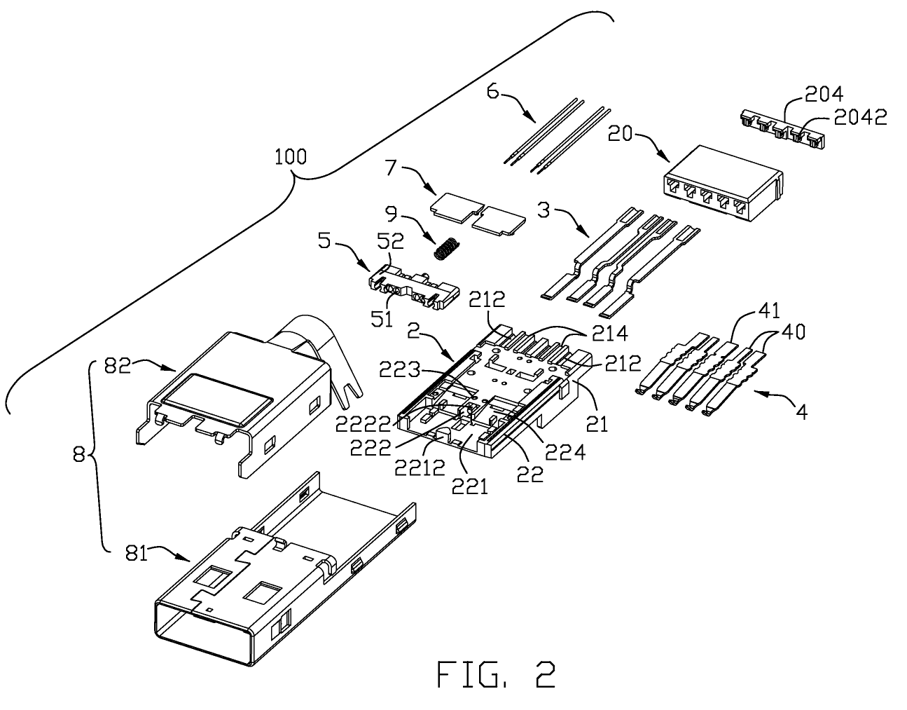

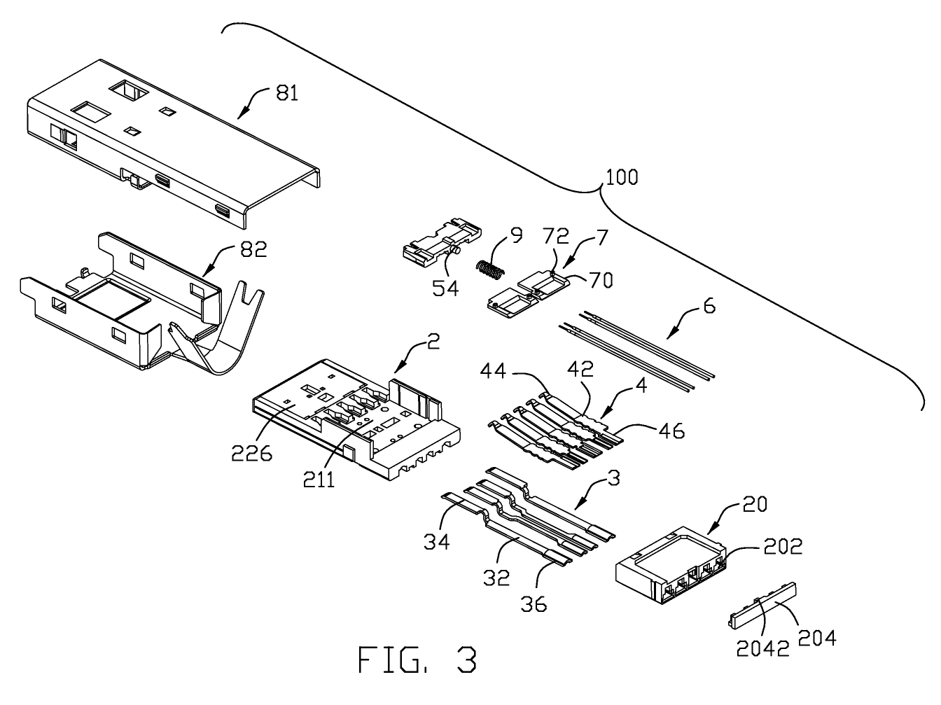

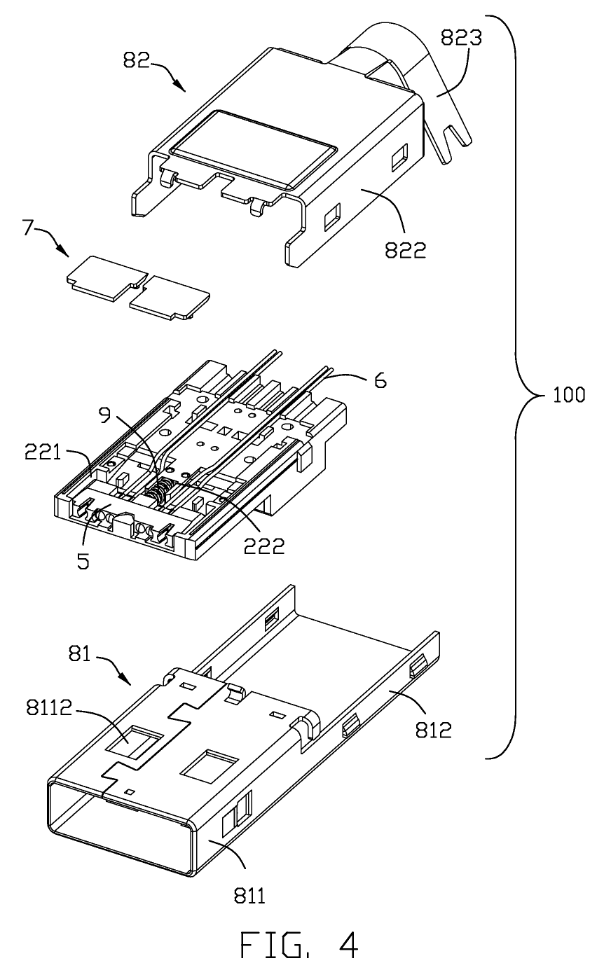

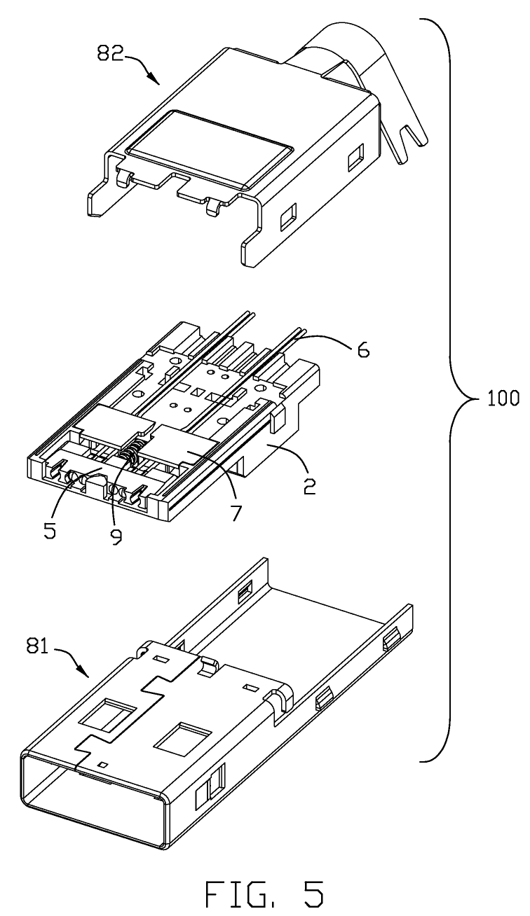

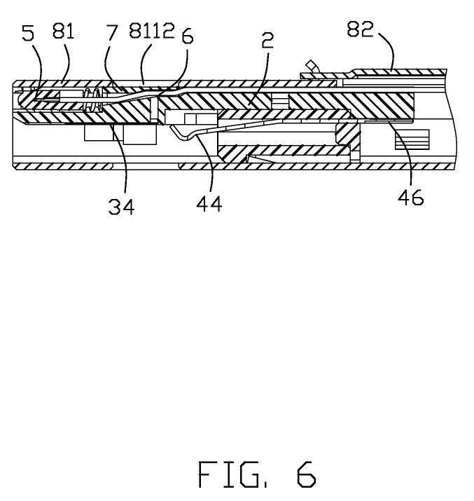

Referring to FIGS. 1-6, a cable assembly 100 according to the first embodiment of the present invention is disclosed. The cable assembly 100 comprises an insulative housing 2, a set of first contacts 3, a set of second contacts 4 and a optical modules 5 supported by the insulative housing 2, and a number of fibers 6 connected to the optical module 5. The cable assembly 1 further comprises a cap member 7 and a metal shell 8. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22 and the base portion 21. A stopping member 2212 is formed in a front portion of the mounting cavity 221. A positioning slot 222 is defined in a rear side of the mounting cavity 2212 and located within the mounting cavity 221. A positioning post 2222 is arranged in the positioning slot 222. Two depressions 224 are defined in the rear part of the tongue portion 22 and located within the mounting cavity 221. The two depressions 224 are disposed opposite sides of the positioning slot 222. A number of contact slots 212 are defined in an upper segment of a rear portion of the base portion 21, and two fiber slots 214 are also defined in the upper segment of the rear portion of the base portion of the base portion 21. The two fiber slots 214 are disposed between the two pair of adjacent fiber slots 214, respectively.

The set of first contacts 3 has four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depression 226 of the lower section of the front segment of the tongue portion 22, and a tail portion 36 extending rearward from the retention portion 32 and accommodated in the terminal slots 212.

The set of second contacts 4 has five contact members arranged in a row along the transversal direction and combined with an insulator 20. The set of second contacts 4 are separated into two pair of signal contacts 40 for transmitting differential signals and a grounding contact 41 disposed between the two pair of signal contacts 40. Each signal contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the corresponding mounting cavity 221. Furthermore, a coil spring member 9 is engaged with the holder member 52, with a protrusion portion 54 of the holder member 52 extending into an interior of a front segment of the spring member 9. A rear end of the spring member 9 is accommodated in the positioning slot 222, and the positioning post 2222 projects into the rear end of the spring member 9. Therefore, the optical module 5 is capable of moving backwardly and forwardly within the mounting cavity 221.

Four fibers 6 are separated into two groups and pass through the fiber slots 214, enter the two depressions 224 and are coupled to the four lens 51, respectively. Each cap member 7 has a body portion 72 and two crush posts 72 formed on a bottom surface thereof. The cap member 7 is assembled to the tongue portion 22, with body portion 72 accommodated in the corresponding depression 224 to cover and secure the fibers 6 in the depression 224, and the crush posts 72 are inserted into holes 223 in the tongue portion 22.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 811 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap members 7 arranged underneath the windows 811, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

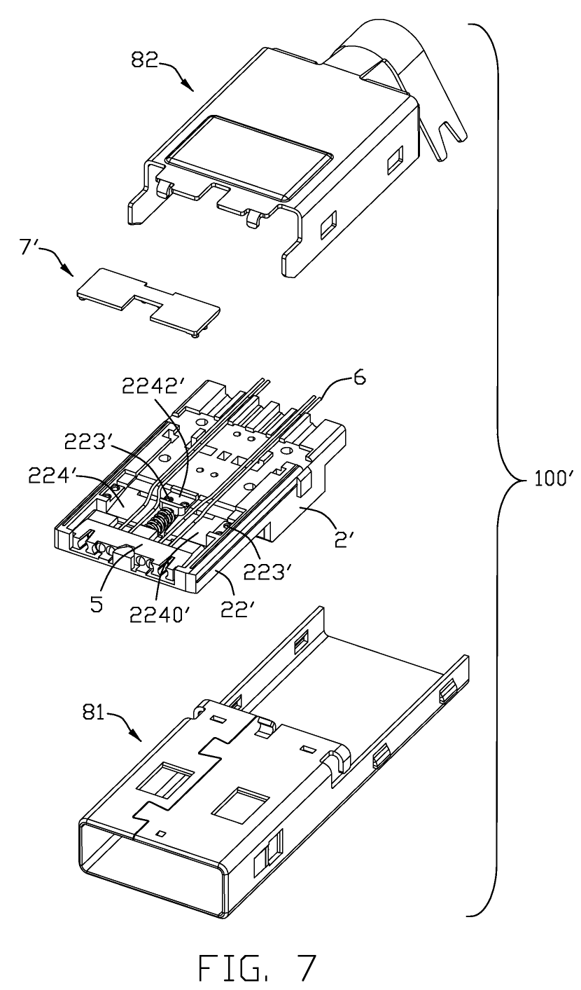

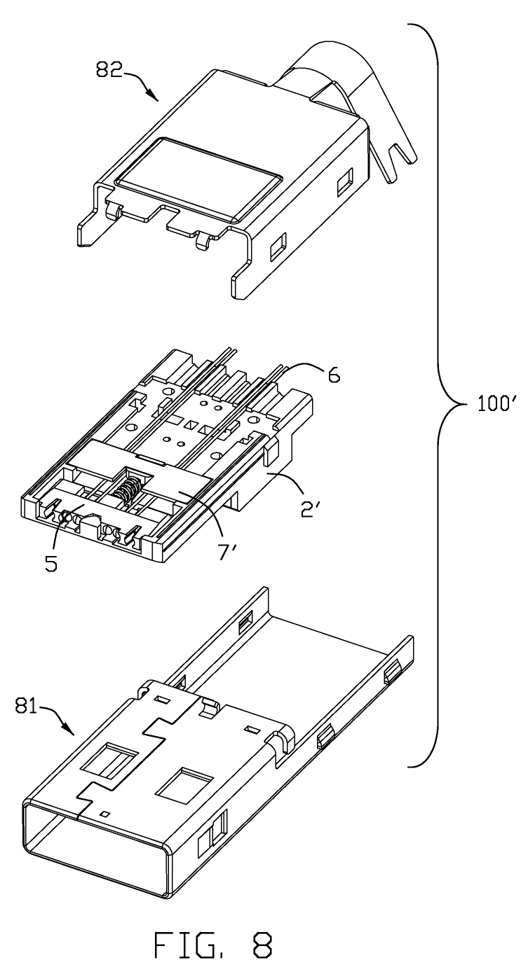

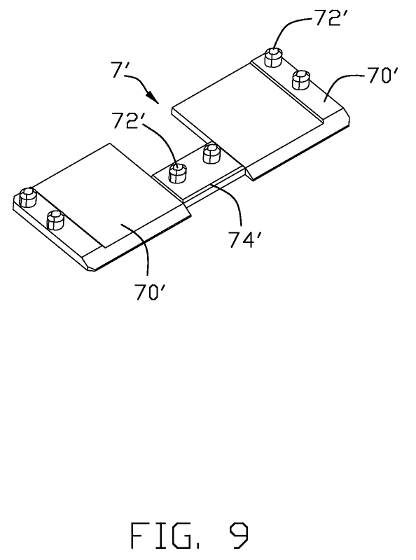

Referring to FIGS. 7-9, a cable assembly 100′ according to the second embodiment of the present invention is disclosed. The cable assembly 100′ in the second embodiment is similar with the cable assembly 100 in the first embodiment, except for a cap member 7′ and an insulative housing 2′. The cap member 7′ has two body portions 70′ arranged in parallel manner and connected together by a bridge portion 74′. Each body portion 70′ has two crush posts 72′ formed on a lateral side thereof. Furthermore, two crush posts 72′ are formed on the bridge portion 74′. The insulative housing 2′ has a depression 224′ which has similar configuration as the cap member 7′. The depression 224′ has two sub-depressions 2240′ and a channel 2242′ in communication with the two sub-depressions 2240′. Four holes 223′ are divided into two groups and defined in lateral sides of the tongue portion 22′ to receive the crush posts 72′ of the two body portions 70′. Other two holes 223′ are defined in the channel 2242′. The fibers 6 pass through the depression 224′ and connected to an optical module 5. The cap member 7′ is accommodated in the depression 224′, with body portions 70′ located in the sub-depressions 2240′ respectively, the bridge portion 74′ received in the channel 2242′. Therefore, the fibers 6 are positioned in the depression 224′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. A cable assembly, comprising:
an insulative housing having a base portion and a tongue portion extending forwardly from the base portion, said tongue portion defining a mounting cavity and at least two depressions, said two depressions located behind and located within the mounting cavity;
an optical module accommodated in the mounting cavity, said optical module having two lenses;
two fibers passing through the two depressions and coupled to the two lenses, respectively; and
two cap members accommodated in the two depressions to position the fibers therein.

2. The cable assembly as claimed in claim 1, wherein each cap member has a body portion and a crush post formed thereon and inserted into a hole defined in the tongue portion.

3. The cable assembly as claimed in claim 1, wherein a spring member is disposed behind the optical module.

4. The cable assembly as claimed in claim 3, wherein a protrusion portion is formed on the optical module and extends into a front segment of the spring member.

5. The cable assembly as claimed in claim 4, wherein a positioning slot is located behind and located within the mounting cavity, and a rear segment of the spring member is received in the positioning slot.

6. The cable assembly as claimed in claim 5, wherein a positioning post is arranged in the positioning slot and the positioning post is inserted into the rear segment of the spring.

7. The cable assembly as claimed in claim 1, further comprising a plurality of contacts supported by the insulative housing.

8. The cable assembly as claimed in claim 7, wherein the contacts are divided into a set of first contacts and a set of second contacts.

9. The cable assembly as claimed in claim 8, wherein mating portions of the first contacts are spaced apart from mating portions of the second contacts along a front-to-back direction.

10. The cable assembly as claimed in claim 8, wherein mating portions of the first and second contacts and the optical module are disposed at opposite sides of the tongue portion.

11. A cable assembly, comprising:
an insulative housing having a base portion and a tongue portion extending forwardly from the base portion, said tongue portion defining a mounting cavity and a depression, the depression located behind and located within the mounting cavity;
an optical module accommodated in the mounting cavity and capable of moving therein;
at least two fibers passing through the depression and coupled to the optical module; and
a cap member accommodated in the depression to position the fibers therein.

12. The cable assembly as claimed in claim 11, wherein the depression has two sub-depressions and the cap member has two body portions accommodated in the two sub-depressions, respectively.

13. The cable assembly as claimed in claim 12, wherein the depression further has a channel in communication with the two sub-depressions, and the cap member has a bridge portion connecting the two body portions and received in the channel.

14. The cable assembly as claimed in claim 12, wherein a crush post is formed on each body portion and inserted into a hole defined in a lateral side of the tongue portion.

15. The cable assembly as claimed in claim 13, wherein a crush post is formed on the bridge portion and inserted into a hole defined in the channel.

16. The cable assembly as claimed in claim 11, further comprising a plurality of contacts which are divided into a set of first contacts and a set of second contacts, wherein the set of first contacts are mounted to the insulative housing, the set of second contacts combined with an insulator and mounted to the insulative housing.

17. An hybrid connector for transmission of electrical and optical signals, comprising:
an insulative housing defining an electrical mating port and an optical mating port offset from the electrical mating port in both a mating direction and a vertical direction perpendicular to said mating direction;
two different sets of contacts disposed in the housing and exposed to the electrical mating port;
an optical module assembled to the optical mating port, said optical module including:
a holder member;
a plurality of lenses retained in the holder member;
a plurality of rearwardly extending fibers connected to the corresponding lenses, respectively;
a spring constantly urging the lenses forwardly; and
a cap restraining said fibers in the vertical direction.

18. The hybrid connector as claimed in claim 17, wherein restraint from the cap with regard to the fibers occurs around a position where said fibers extend not only rearwardly but also in the vertical direction away from said electrical mating port.

19. The hybrid connector as claimed in claim 18, further including a metallic shell enclosing the housing and cooperating with the housing to sandwich said cap therebetween for retaining said cap in position in the vertical direction, wherein complementary interengaging devices are formed on said cap and at least one of said housing and said shell for preventing relative movement of the cap with regard to the housing in the mating direction.

20. The hybrid connector as claimed in claim 17, wherein said spring directly urges said holder member forwardly, thus resulting in urging the lenses forwardly.
